(19) United States
(12) Patent Application Publication
(10) Pub. No.: US 2009/0182707 A1
(43) Pub. Date: Jul. 16, 2009

(54) DATABASE CHANGESET MANAGEMENT SYSTEM AND METHOD

(75) Inventors: Robert Kinyon, Marysville, OH (US); Seth Blank, San Francisco, CA (US)

Correspondence Address: ADVANTIA LAW GROUP, 9035 SOUTH 1300 EAST, SUITE 200, SANDY, UT, 84094, US

(73) Assignee: DBIX CORPORATION, San Francisco, CA (US)

(21) Appl. No.: 12/351,343

(22) Filed: Jan. 9, 2009

Related U.S. Application Data
(60) Provisional application No. 61/020,246, filed on Jan. 10, 2008.

(51) Int. Cl. G06F 17/30

(52) U.S. Cl. 707/2; 707/E17.017

(57) ABSTRACT

A method of database changeset management for automated information enhancement and control over changesets using a computational device. The steps include: analyzing and processing a query; journaling the query into a changeset-journaling module; recording a blocking journal entry based on a blocking characteristic of the query into a journal blocker module; sending a database mutation statement to a database. Undo requests are checked against the blocking journal before execution. Further steps include: triggering an interest protocol on a match of a query with an interest set; returning a response to a query based solely on information from a changeset-journaling module; comparing an actual return from the database to an expected return and generating a difference statement therebetween; providing a collaboration module; and providing a second changeset-journal module configured to journal an alternate database state; and returning a query result based on the alternate database state.

### CROSS-REFERENCE TO RELATED APPLICATIONS

This invention claims priority, under 35 U.S.C. §120, to the U.S. Provisional Patent Application No. 61/020,246 by Robert Kinyon filed on 10 Jan. 2008, which is incorporated by reference herein in its entirety.

### BACKGROUND OF THE INVENTION

1. Field of the Invention

The present invention relates to database management, specifically to database changeset management systems and methods.

2. Description of the Related Art

In the related art, it has been known to use database management systems and methods to manage databases. Databases are utilized in almost every facet of business and entertainment computing. They provide back-end information for many applications that people use on a daily basis, including banking, websites, inventory control, customer management tools, and many others. Some databases grow to tremendous sizes and all include information that is important to the associated applications. Accordingly, proper management of databases has been the subject of intense innovation.

In particular, some management systems restrict access according to defined protocols to enhance security. Others process queries according to protocols configured to enhance management of a target database. Still others alter how queries are sent and/or received in order to enhance results provided to an application or performance of a database, such as through special encryption techniques. Some improvements have been made in the field. Examples of references related to the present invention are described below in their own words, and the supported teachings of each reference are incorporated by reference herein:

U.S. Pat. No. 5,355,474, issued to Thuraisngham et al., discloses an apparatus “for an integrated architecture for an extended multilevel secure database management system. The multilevel secure database management system processes security constraints to control certain unauthorized inferences through logical deduction upon queries by users and is implemented when the database is queried through the database management system, when the database is updated through the database management system, and when the database is designed using a database design tool.”

U.S. Pat. No. 6,823,328, issued to Schreiber, discloses “a system and method for enabling unified access to multiple data types. The invention retrieves data regardless of data format. The system does not distinguish among data formats. The system determines a format for data to be retrieved and retrieves the data. An attribute for the data may also be retrieved. Preferably, the attribute is retrieved based on an attribute number. The system may store a value and syntax for the data retrieved identifying a format for the data.”

U.S. Patent Publication No. 2004/0186829, filed by Suzuki et al., discloses a “query posing method is implemented in a database system comprising a plurality of database servers each of which includes a database from which the same content can be retrieved and searches the database in response to a query request a front-end server that poses a query according to a predetermined rule and a management server that manages rules to be used by the front-end server. The management server acquires a processed query log relevant to a database server, and produces a rule according to the compatibility value of a query calculated using the acquired processed query log. Moreover, the front-end server poses the query according to the rule produced by the management server.”

U.S. Pat. No. 5,713,018, issued to Chan, discloses a “distributed computer system has an information server and a plurality of client computers coupled by one or more communication paths to the information server. The information server includes a database management system (DBMS) with an interface procedure for receiving and responding to SQL statements from client computers. At least one client computer has a database access procedure for sending SQL statements to the DBMS in the information server. The database access procedure includes embedded encrypted SQL statements, representing a predefined subset of a predefined full set of SQL statements recognized as legal SQL statements by the DBMS. For instance, the predefined subset of SQL statement might include only SQL statements for reading data in the DBMS, but not include SQL statements for modifying and adding data to the DBMS. Each of the SQL statements sent by the database access procedure to the DBMS includes a corresponding one of the encrypted SQL statements. The DBMS in the information server includes an interface procedure for processing all SQL statements received from client computers, including a decoding procedure for decoding the encrypted SQL statement included in the SQL statements sent by the database access procedure in the one client computer. The received SQL statement is executed by the DBMS only if the decoded SQL statement is a legal SQL statement. In addition, the interface procedure rejects received SQL statements that do not include an encrypted SQL statement.”

U.S. Publication No. 2007/0067334, filed by Durbin, discloses a “method for use with a database management system to produce a data structure encoded in computer readable memory that indicates a role associated with a transaction comprising: obtaining page context information that includes userid, subjectid, page name and a transaction identifier; providing a plurality of role views that associate userids and subjectids with role names; using the page name from the page context information to access a page definition relation that provides an association between the page name and at least one subject name; using the at least one subject name from the page definition relation to access a access a role view list that lists one or more of the role views; using the userid and the subjectid from the page context and at least one role view name from the role view list to access at least one role view that includes a matching userid and a matching subjectid; and producing a log roles structure that associates a role name from the at least one accessed role view and a transaction identifier from the page context.”

The following references are also incorporated herein for their supporting teachings: U.S. Pat. No. 7,277,884 B2 by Vadai et al.; U.S. Pat. No. 5,694,590 by Thuraisingham et al. and U.S. Pat. No. 7,266,516 by Song et al.

The inventions heretofore known suffer from a number of disadvantages which include inability to track changes, failure to secure a database, failure to protect data against tampering, inability to observe impacts of statements without compromising database integrity, inordinately increasing processing or other costs, requiring too many steps, and failing to facilitate collaboration among applications.

What is needed is a management system and/or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available information management systems. Accordingly, the present invention has been developed to provide a changeset management system.

In one embodiment, there is a database changeset management system configured to generate a record of changesets for a database, comprising: an application-interface module configured to receive queries from an application and provide returns to an application; a query-analysis module in communication with the application-interface module and configured to analyze a query according to an analysis protocol; a query-processing module in communication with the query-analysis module and configured to process queries according to a processing protocol thereby generating database mutation statements; a changeset-journaling module in communication with the query-processing module and configured to journal database mutations based on database mutation statements; a journal-blocker module in communication with the changeset-journaling module and configured to record blocking relationships among journaled database mutations; and/or a database-interface module in communication with the query-processing module and configured to send queries to and receive returns from a database.

It may also be that the changeset-journaling module does not restrict journaled database mutations to any particular data type. More, the application-interface module may be integrated into an application as a connector decorator, the application-interface module and the database-interface module may be in modular communication with the application and the database, respectively, such that the database changeset management system is middleware between the application and the database, and/or the database-interface module may be integrated into a database as a stored procedures system. Further, it may be that the query-analysis module matches queries against a characteristic set and triggers an interest protocol on a match.

Additionally, there may be a database-restriction module in communication with the query-processing module and configured to return selective queries based only on expected returns derived from the changeset-journaling module, thereby reducing required communication through the database-interface module; a return-check module in communication with the database-interface module and configured to compare an actual return from a database to an expected return derived from the changeset-journaling module; a return subtraction module in communication with return-check module and configured to return a difference between an actual return and an expected return; a collaboration module in communication with the application-interface module and configured to permit a plurality of applications to collaborate simultaneously with the changeset management system; an alternate-state-return module in communication with the query processing module and configured to return based on a conditional state of the database; and/or an undo module in communication with the journal-blocking module and configured to facilitate mutation reversal.

In another embodiment there may be a method of database changeset management for automated information enhancement and control over changesets using a computational device, the steps comprising: receiving a query from an application; analyzing the query according to an analysis protocol; processing the query according to a processing protocol, thereby generating a processed query having database mutation statements; journaling a database mutation statement into a changeset-journaling module; recording a blocking journal entry based on a blocking characteristic of the processed query into a journal blocker module; sending a database mutation statement to a database; and/or checking an undo request against the blocking journal entry.

Further steps may include: comparing a query to an interest set and triggering an interest protocol on a match; returning a response to the query based solely on information from the changeset-journaling module; deriving an expected return from information stored in the changeset-journaling module; comparing an actual return from the database to the expected return; generating a difference instruction between the actual return and the expected return, wherein the difference instruction includes a set of statements configured to transform between the actual and expected returns; providing a list of journal ids for all journals within a specified timeframe and satisfying a predetermined characteristic; providing journal information in response to a query regarding a provided journal id; providing a second changeset-journal module configured to journal an alternate database state; and/or returning a query result based on the alternate database state.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram showing a changeset management system in operational context between an application and a database, according to one embodiment of the invention;

FIG. 2 is a flowchart showing a method of changeset management, according to one embodiment of the invention;

FIG. 3 is a sequence diagram showing a method of changeset management, according to one embodiment of the invention;

FIG. 4 is a flowchart illustrating a method of processing and executing a query and creating a journal entry, according to one embodiment of the invention;

FIG. 5 is a set of flowcharts showing methods of executing management commands, according to one embodiment of the invention;

FIG. 6 is a set of flowcharts showing methods of executing management commands, according to one embodiment of the invention;

FIGS. 7 and 8 together form a relational object diagram illustrating tables/objects of a changeset management system, according to one embodiment of the invention;

FIG. 9 is a sequence diagram showing a method of changeset management, according to one embodiment of the invention;

FIG. 10 is a block diagram showing a changeset management system in operational context, according to one embodiment of the invention;

FIG. 11 is a flowchart showing implementation of “time machine” function of a method of changeset management, according to one embodiment of the invention;

FIG. 12 is a flowchart showing implementation of collaboration function of a method of changeset management, according to one embodiment of the invention; and

FIG. 13 is a block diagram showing modules of a changeset management system, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” “an example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: changeset management tables; notice caches and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with or without access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, Perl, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

All of the features, functions, method steps, actions, procedures, behaviors, activities, devices, and the like described herein are considered to be embodied in one or more modules and should be read as if the word “module” were inserted directly after nomination or other characterization of such. Further, it is envisioned that various embodiments of the invention include one or more such modules in one or more combination as described herein and that all such permutations are specifically considered as if presented in a multidimensional grid herein. More, it is envisioned that various embodiments also include devices, systems, and methods that are limited to consist of and/or consist essentially of only certain such modules. Purposes of the invention for the purpose of defining “essentially” include providing one or more of the benefits described herein.

Furthermore, the use of the terms “journal” and the like relate to recording and managing database changesets and are not used in the typical sense of database journaling.

The term “mutation,” “database mutation” and the like include data alterations and instructions to change data or having a capability of affecting any change in a target database.

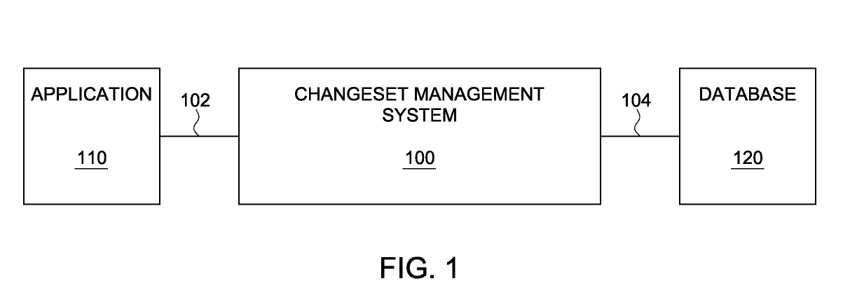

FIG. 1 is a block diagram showing a changeset management system in operational context between an application and a database, according to one embodiment of the invention. There is shown an application 110 in communication 102 with a changeset management system 100 that is also in communication 104 with a database. Each may include one or more modules configured to carry out the purposes of each. Accordingly, the illustrated application 110 may, through the changeset management system 100, interact with the database 120. Advantageously, the changeset management system 100 may facilitate recording, comparing, controlling, securing and otherwise managing database mutations.

The illustrated application 110 may be software/hardware having a need to interact with a database. Non-limiting examples include: CRM tools, inventory management software, enterprise management tools, web pages, POS software/hardware, Massively Multiplayer Online Role-Play Games, and the like. Such applications are generally configured to submit database queries configured to poll or mutate a database.

The illustrated database 120 may be software/hardware having the capability to store structured information in a computing system. Non-limiting examples include: Microsoft SQL, MySQL, and Oracle.

Communication between the application, changeset management system and database may include modular connectivity between discrete systems, integration of systems, and variations and combinations thereof. For example, the changeset management system may be integrated into either or both the application and database. In another non-limiting example, a changeset management system may be configured to communicate with a plurality of separate and independent applications and/or communicate with a plurality of separate and independent databases. Communication may be over a network, through a memory address, across a bus, and etc.

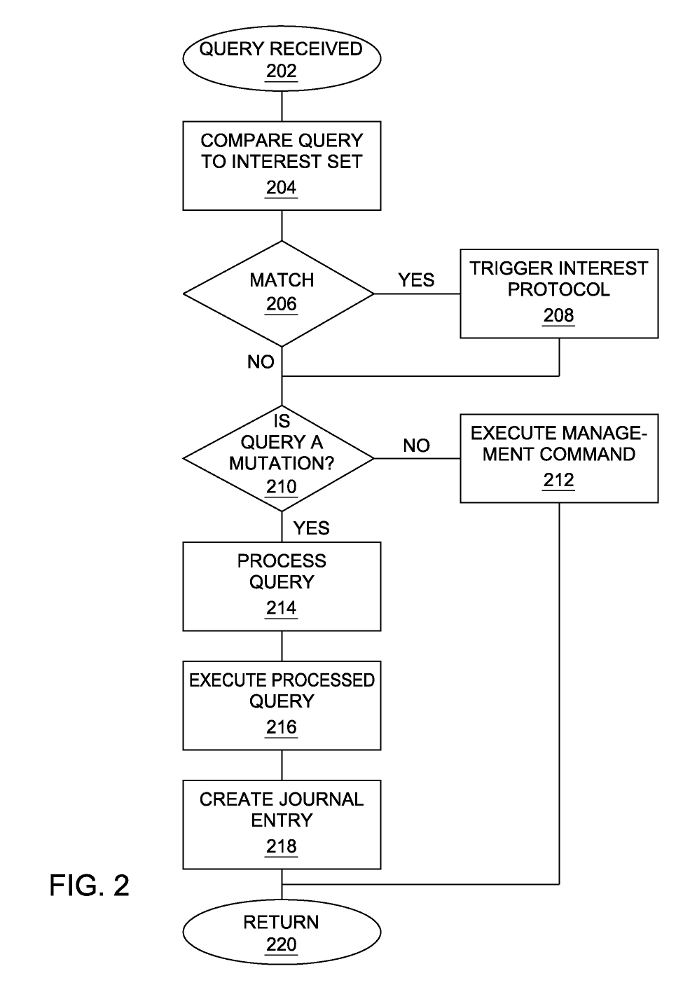

FIG. 2 is a flowchart showing a method of changeset management, according to one embodiment of the invention. In the illustrated method, a computational device receives a query, analyzes the query, processes the query according to a processing protocol, executes the processed query, journals the query/processed query, and returns a statement to the application. In one embodiment, a query is defined as a single statement (such as a SQL statement). One or more queries may be bundled into a database transaction that is treated by the database as an atomic unit. One or more database transactions may be bundled and is treated by a changeset management system as an atomic unit. Advantageously, a query may be managed and conditional and non-conditional actions may be taken in regards to the query that facilitate management of changesets/mutations. Further, information enhancement and changeset control may be automated.

In the illustrated example, a computational device receives 202 a query from an application and then analyzes and processes the query by matching the query to an interest set and by evaluating the intent of the query. Accordingly, the system may act on the query according to the “interests” of the source of the query and the operator of the changeset management system.

The illustrated method compares 204 the query to an interest set to determine if the query is of particular interest, such as but not limited to causing a mutation in a table of interest, requesting data having a particular value, being received from a particular application or user within the application, source user, source application, time of query, table(s) queried/affected, record(s) queried/affected, query complexity, transaction combination and the like. The interest set may be compared to any observable or calculable characteristic of the received query package. Wherein the query matches 206 a portion of the interest set an interest protocol associated with the matching portion of the interest set is triggered 208. For example, a log may be generated of interest set matching queries, such a query may be automatically modified, may be ignored, and etc. In one embodiment, a matching query may be tagged, such that a metadata tag is applied to the query, to any journal created as a result of the query, or to other data related to the query. Such tags may be later searched, may trigger events, such as but not limited to alerts or notices, may trigger undo operations, may trigger providing an alternate Return, may trigger restricting actualization of the query, and the like and any combinations thereof. Wherein the query does not match the interest set, an interest protocol is generally not triggered

In the illustrated method, the query is further analyzed 210 to determine if the query is a mutation or a management command and processed further appropriately. Accordingly, a query may contain commands to be executed by the changeset management system and/or may include one or more mutations to be executed on a target database. A mutative query may be processed 214 in preparation for execution 216 on the target database. Processing may include, but is not limited to, parsing the query, translating query statements from one format/protocol to another, determining the mutative intent of a query and replacing sets of commands with more efficient/less efficient variants as desired, and appending desired mutations or other statements to the query where desired for the purposes of the system. The processed query is provided to the database and mutations and etc. may be executed 216. A journal entry(s) is created 218 regarding the query, its processing, and/or its execution and information is returned 220 to the application. A journal entry may include recording a blocking journal entry based on a blocking characteristic of the processed query into a journal blocking module. For example, wherein a mutation affects a particular table, row, or etc. a blocking journal entry may be created indicating that the affected table, row, or etc. has been changed and may be blocked from an “undo” request unless the mutation is reversed. Reversal of a mutation may generate further blocking journal entries accordingly.

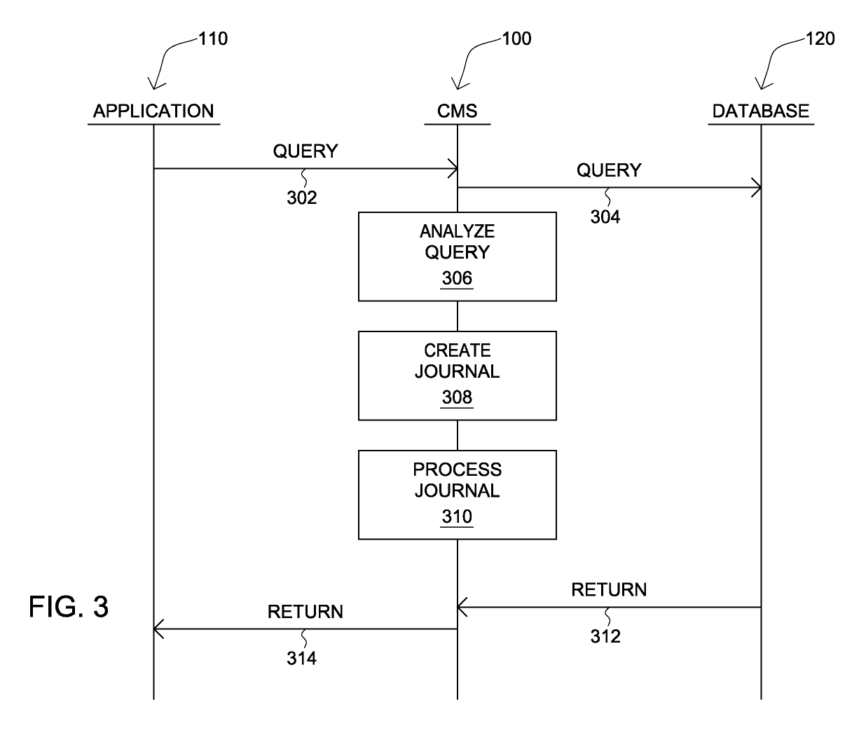

FIG. 3 is a sequence diagram showing a method of changeset management, according to one embodiment of the invention. In the illustrated embodiment, a query 302 is received by a changeset management system (CMS) 100 from an application 110. A related query 304 is provided to a database (may or may not be identical to query 302). The received query is analyzed 306, a journal relating to the query is created 308 and processed 310 according to results of the analysis of the query. Such processing may include, but is not limited to executing a query on another database, generating a journal blocker record, and the like. A return 312 is received from the database 120 and a related return 314 (may or may not be identical to the received return 312) is provided to the application 110.

Advantageously, in the illustrated embodiment, a query may be journaled and a CMS may act on the query and may facilitate operation of the CMS, application, and/or database by altering one or more queries or returns. Accordingly, a CMS may provide benefits heretofore unrealized by management systems. In an alternate embodiment, related queries and returns may be provided after one or more other steps carried out by the CMS.

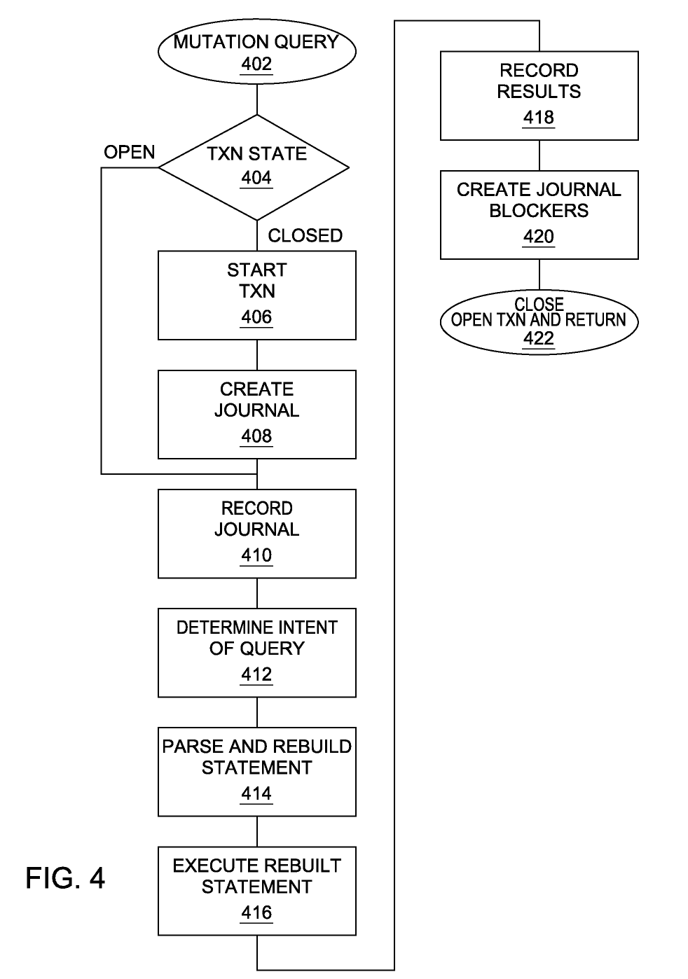

FIG. 4 is a flowchart illustrating a method of processing and executing a query and creating a journal entry, according to one embodiment of the invention. Wherein a mutation query is received 402, the system determines a transaction (“TXN”) state 404 (open or closed, generally). Wherein the state is observed to be closed, a txn is started 406 and a journal associated with the newly opened txn is created 408. These steps are skipped wherein a txn is already open. Then a journal entry is recorded 410 regarding the mutation query, the query is analyzed 412 to determine the intent of the query so that where appropriate the query statement(s) may be parsed and rebuilt 414 according to instructions based on the determined intent. The rebuilt statement(s) is executed 416, results/returns from the database are recorded 418 and journal blockers are created according to the characteristics of the query and the return from the database as appropriate. Nonlimiting examples of fields within a journal blocker table include: parent_id and chid_id such that children block parents. Then the open txn is closed 422 and results are returned to an application. Advantageously, wherein a system follows the described method or one substantially similar thereto, database transactions may be configured to always occur within the context of a changeset management system journal.

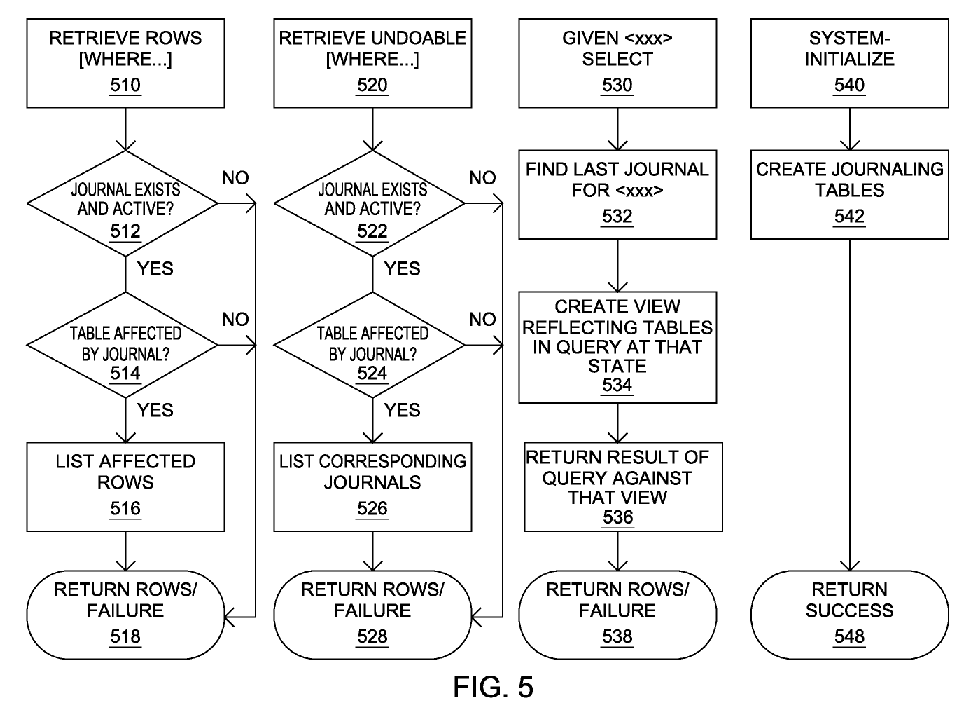

FIG. 5 is a set of flowcharts showing methods of executing management commands, according to one embodiment of the invention. In particular, exemplary steps for the following management commands are illustrated: RETRIEVE ROWS 510, RETRIEVE UNDOABLE 520, GIVEN <XXX> SELECT 530, and SYSTEM_INITIALIZE 540.

The illustrated process for the command RETRIEVE ROWS 510 includes checking to see if an active journal exists 512 and if the relevant table is affected 514 by the journal. Wherein either is not true, the process skips to return 518. Wherein both checks pass, affected rows are listed 516 and returned 518.

The illustrated process for the command RETRIEVE UNDOABLE 520 includes checking to see if an active journal exists 522 and if the relevant table is affected 524 by the journal. Wherein either is not true, the process skips to return 528. Wherein both checks pass, affected rows are listed 526 and returned 528.

The illustrated process for the command GIVEN <XXX> SELECT 530 includes finding 532 the last journal for the argument, creating 534 a view reflecting tables in query at that state, returning 536 a result of query against that view, and returning 538 rows/failure.

The illustrated process for the command SYSTEM_INITIALIZE 540 includes creating journaling tables 542 and returning 548.

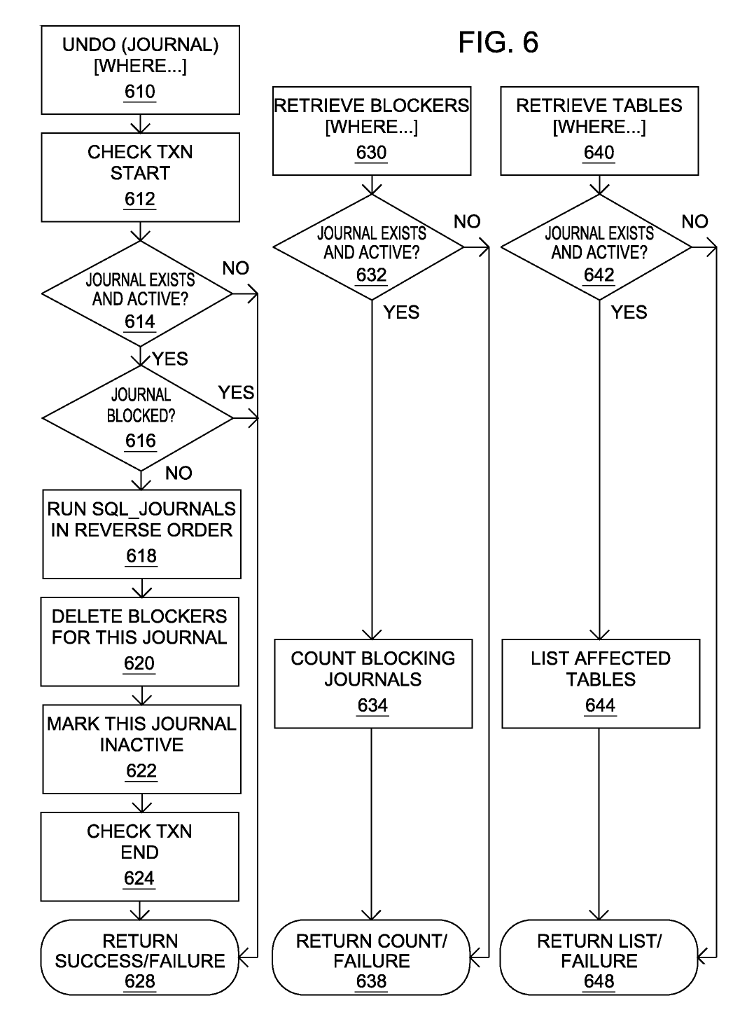

FIG. 6 is a set of flowcharts showing methods of executing management commands, according to one embodiment of the invention. In particular, exemplary steps for the following management commands are illustrated: UNDO 610, RETRIEVE BLOCKERS 630, and RETRIEVE TABLES 640.

The illustrated process for the command UNDO 610 includes checking 612 for txn start to make certain that there is an open txn, checking 614, 616 for an active existing journal that is not blocked (else return 628 failure), running 618 SQL_Journals in reverse order, deleting 620 blockers for the journal 620, marking 622 the journal inactive, checking 624 txn end to make sure the txn is closed, and returning 628. In one embodiment, there is a command that allows for the “undo” of a journal, reversing the effects of all of the changesets within that journal in a safe and consistent manner. Should it be unsafe for a journal to be undone, the changeset management system will note that it is “blocked” from being undone. It is understood that a user may be permitted to undo one or more blocked changesets according to one or more conditions or unconditionally, in one embodiment of the invention.

The illustrated process for the command RETRIEVE BLOCKERS 630 includes checking 632 for an existing and active journal (else return 638) then counting 634 blocking journals and returning 628.

The illustrated process for the command RETRIEVE TABLES 640 includes checking 642 for an existing and active journal (else return 648) then listing 634 affected tables and returning 648.

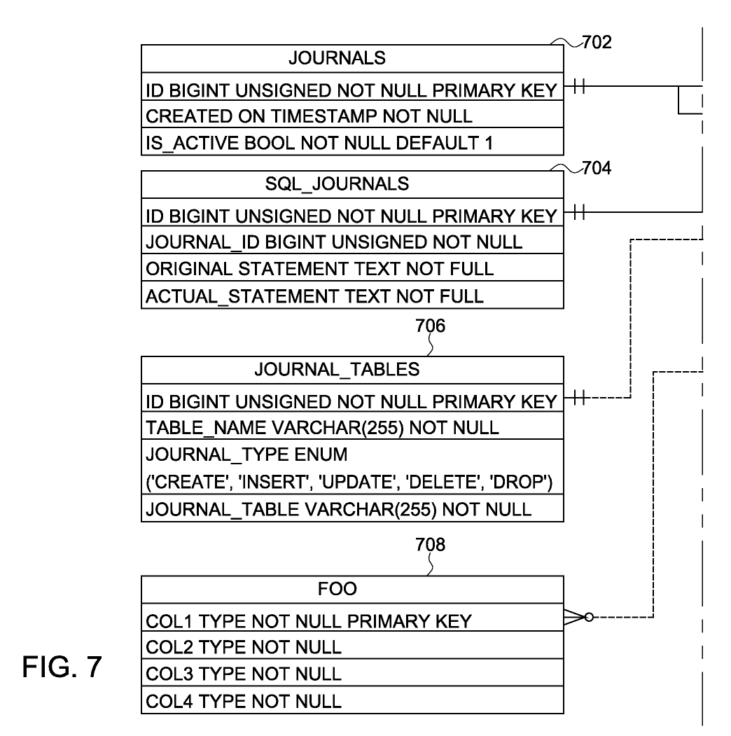

FIGS. 7 and 8 together form a relational object diagram illustrating tables/objects of a changeset management system, according to one embodiment of the invention. Illustrated tables/objects include: JOURNALS 702, SQL_JOURNALS 704, JOURNAL_TABLES 706, FOO 708, JOURNALS_TREE 710, TABLES_AFFECTED 712, FOO_INSERT 714, FOO_UPDATE 716, and FOO_DELETE 718. Names are provided to indicate function and relationship and one skilled in the art would recognize such. “Foo” is a non-specific reference to data tables whose changesets are being managed by a changeset management system. Relationships between the tables are also shown by links between the various table representations and one skilled in the art would recognize such.

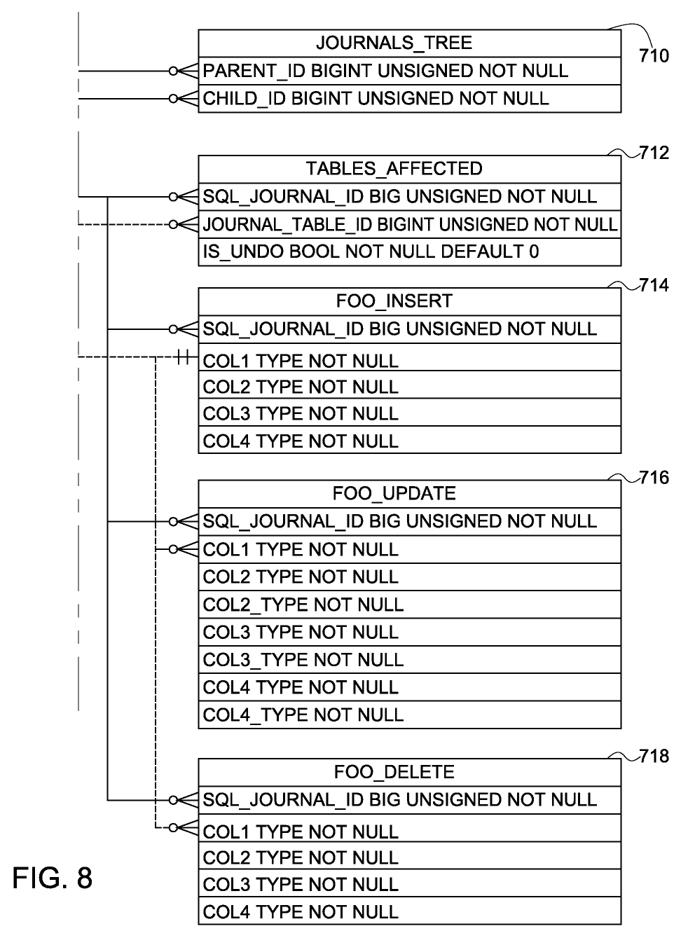

FIG. 9 is a sequence diagram showing a method of changeset management, according to one embodiment of the invention. In particular, there is a method of detecting unauthorized mutative queries according to one embodiment of the invention. There is shown a mutative query that makes a change in the database, wherein the change alters an actual return of the illustrated query from that of an expected return. As the return differs from the expected Return, an administrator or other user may be enabled to detect queries that are not authorized or otherwise not transmitted through the changeset management system. As a nonlimiting example, a database is accessed through an unauthorized channel and a query is made that results in a change to the database. Later an authorized query having an impact on overlapping data with the change resulting from the unauthorized query is sent through the changeset management system. The changeset management system determines an expected return that turns out to be different from the actual return from the modified database. Accordingly, the changeset management system is able to detect the evidence of tampering with the database by the unauthorized query. It is noted that similarly, the changeset management system may also be able to detect tampering with its own data.

In the illustrated method, a changeset management system may perform a “subtraction” against the actual return. A “subtraction” is a process wherein values are compared and processed to determine a sufficient transformation, such that one may be transformed to the other by a series of events (in this case, queries/statements). In such a case, the system may perform the following steps: deriving an expected return from information stored in the changeset-journaling module; comparing an actual return from the database to the expected return; and generating a difference instruction between the actual return and the expected return, wherein the difference instruction includes a set of statements configured to transform between the actual and expected returns. Diff.pm is an SQL diff program written in Perl that performs steps of a method of generating a difference. Such may be used to “diff” a current database against what one may otherwise expect. The following website is incorporated by reference herein for its supporting teachings http://search.cpan.org/˜jrobinson/SQL-Translator-0.09002/lib/SQL/Translator/ (as viewed 6 Jan. 2009). Accordingly, together with changeset journaling, a query or subset of a full table may be audited.

Accordingly, a user may be provided with more information about why an unexpected return exists and what mutation(s) may have been done and detected. In one embodiment of the invention, a subtraction process includes invocation of a “Time Machine” module.

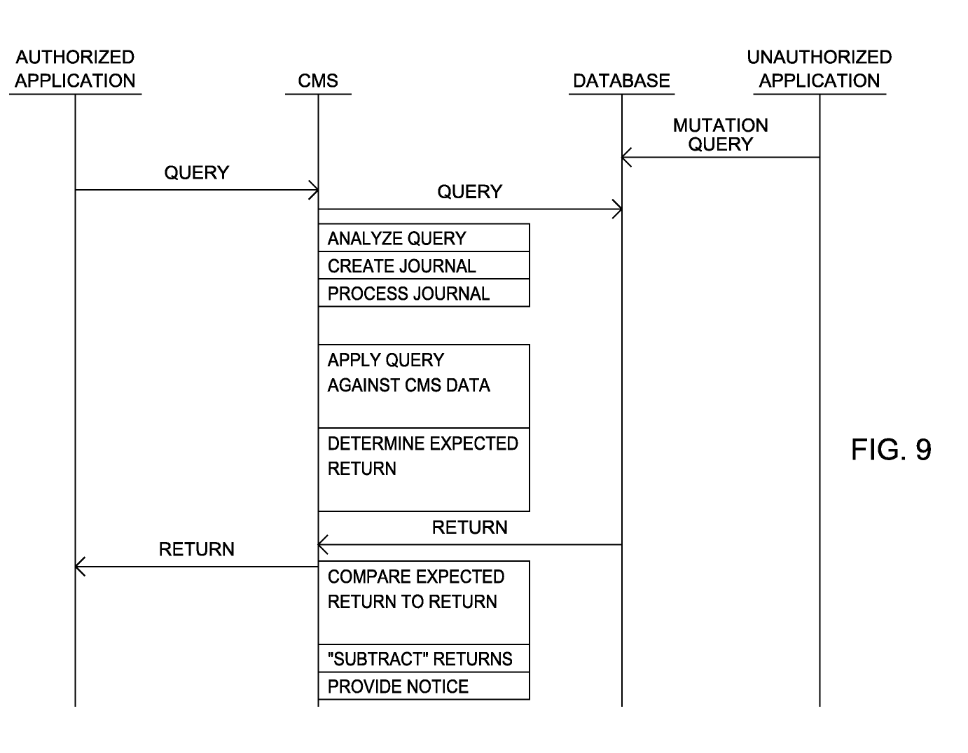

FIG. 10 is a block diagram showing a changeset management system in operational context, according to one embodiment of the invention. In particular, there is shown an application 910 in communication with a CMS 900 in communication with a database 920. Data that is currently stored in the database may, instead or concurrently, be stored within the CMS as changeset logs and/or a dataset 902 that diverges from the database (wherein mutative queries are processed without communicating with the database 920). Accordingly, the connection 906 between the CMS 900 and database 920 may be intermittent, scheduled, non-existent, combinations and variations thereof and etc. In such a mode, queries performed against the database may return quicker by polling changeset information instead of directly accessing the database. This may also help reduce transaction burdens on the database itself, especially for non-mutative queries. In this way a CMS may act as a cache with enhanced capability of being able to perform and track mutations without disturbing the database by returning a response to the query based solely on information from the changeset-journaling module. Such may also be utilized to generate an alternate version of a database that may be utilized in database security, forecasting, and etc.

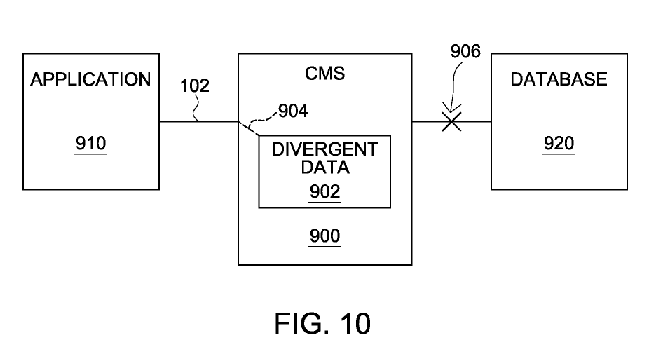

FIG. 11 is a flowchart showing implementation of “time machine” functionality of a method of changeset management, according to one embodiment of the invention. The concept of data retrieval from hypothetical and/or historic data sets is sometimes referred to as “time machine” throughout this application. There is shown a process of creating a modified view of a database and executing a statement against the modified view. An example is also provided.

In the illustrated method, a client/application issues 1110 a SQL statement configured to invoked operation of a time-machine module (also called herein an alternate-state-return module). The time machine module creates a view of the target database (or second changeset journal module) corresponding to certain portions of the SQL statement (combined with the target database creating an alternate database state), without actually executing those portions on the target database. The SQL statement is then executed 1130 against the view and results are returned to the application. Accordingly, an application may receive a return based on an unexecuted statement. Advantageously, an application may be enabled to “try out” a set of statements before actual execution and other investigative and/or forecasting activities may be carried out without violating the integrity of the target database.

In one embodiment, a Time Machine module enables a user to create a modified view based on a modification other than a snapshot in time. Non-limiting examples include views modified by removing or otherwise altering data based on: custom meta-tags (as described elsewhere in this application, such as but not limited to application source, user source, and etc.), tables, table sets, table contents, and the like and combinations thereof. Accordingly, in one non-limiting example, an administrator may be enabled to create a view of a database wherein all changes by Employee X after Date Y are as if they had never occurred.

In one exemplary embodiment, The Time Machine creates a 3-dimensional resultset (as compared to the normal 2-dimensional resultset SQL provides). The dimensions here are rows, columns, and time. So, for any given row in a table, there may be a transparent stack of changesets from the initial insertion at the bottom all the way to the final edit or deletion at the top. Then, when a given column's value is requested for that row, a changeset management system will process through the stack until it finds a changeset with a value for that column in that row, then return that.

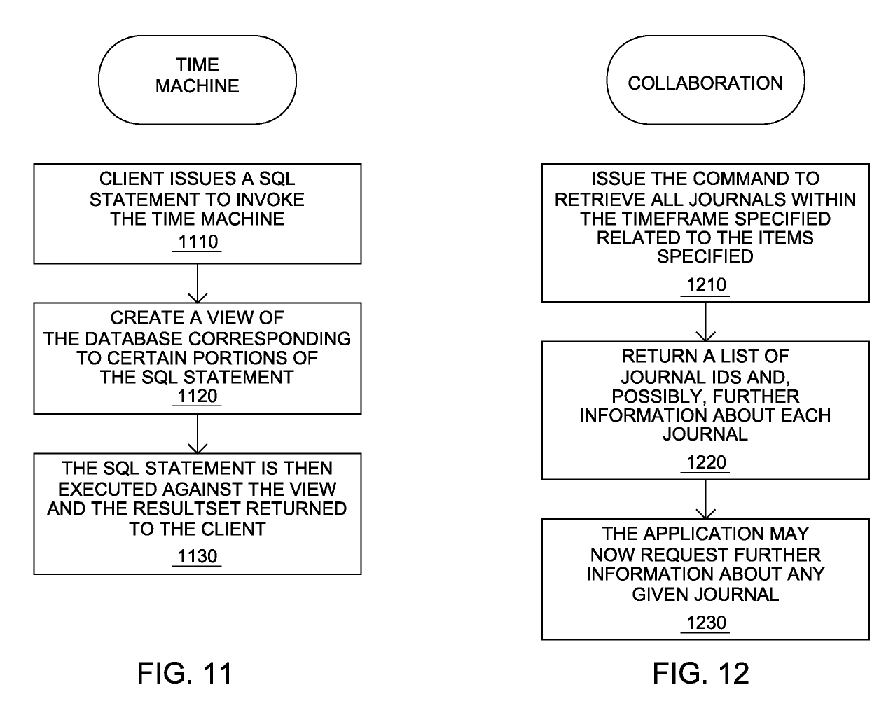

FIG. 12 is a flowchart showing implementation of collaboration functionality of a method of changeset management, according to one embodiment of the invention. In the illustrated method, an application issues 1210 a command to retrieve all journals within a specified timeframe and related to specified items. A list of journal ids is returned 1220 based on the parameters of the command. Having the appropriate journal ids, the application(s) may request more specific information about each journal.

In one non-limiting example a set of users log into a network and download a current state of a database (may represent a document, spreadsheet, portion of code, etc.). The users are each viewing the state of the same database (document, etc.) and may or may not be viewing such with the same or similar application (browser, desktop application, etc.). A first user makes a change to a document through a first application. The change is processed and stored remotely. A second user is notified (through polling, having the change pushed thereto, etc.). Because the second user already has a state of the database, only the changeset needs to be received and processed over the state as viewed by the second user.

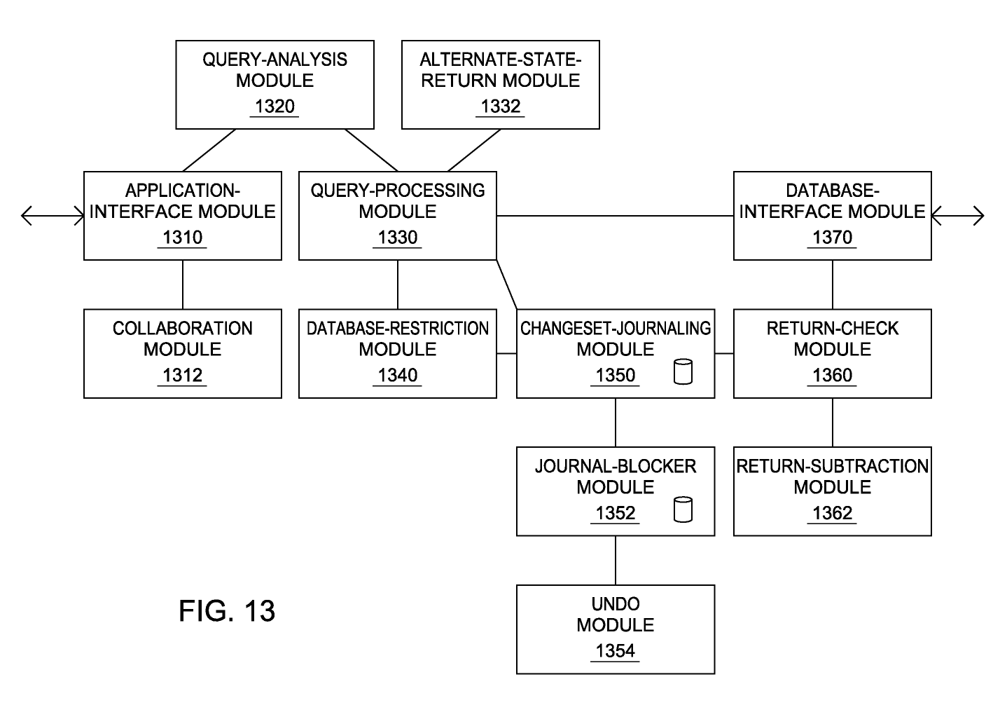

FIG. 13 is a block diagram showing modules of a changeset management system, according to one embodiment of the invention. There is shown a database changeset management system configured to generate a record of changesets for a database. The illustrated system includes: an application-interface module 1310 configured to receive queries from an application and provide returns to an application; a query-analysis module 1320 in communication with the application-interface module 1310 and configured to analyze a query according to an analysis protocol; a query-processing module 1330 in communication with the query-analysis module 1320 and configured to process queries according to a processing protocol thereby generating database mutation statements; a changeset-journaling module 1350 in communication with the query-processing module 1330 and configured to journal database mutations based on database mutation statements; a journal-blocker module 1352 in communication with the changeset-journaling module 1350 and configured to record blocking relationships among journaled database mutations; and a database-interface module 1370 in communication with the query-processing module 1330 and configured to send queries to and receive returns from a database.

Additionally, the illustrated system includes a database-restriction module 1340 in communication with the query-processing module 1330 and configured to return selective queries based only on expected returns derived from the changeset-journaling module 1350, thereby reducing required communication through the database-interface module 1370; a return-check module 1360 in communication with the database-interface module and configured to compare an actual return from a database to an expected return derived from the changeset-journaling module 1350; a return subtraction module 1362 in communication with return-check module 1360 and configured to return a difference between an actual return and an expected return; a collaboration module 1312 in communication with the application-interface module 1310 and configured to permit a plurality of applications to collaborate simultaneously with the changeset management system; an alternate-state-return module 1332 in communication with the query processing module 1330 and configured to return based on a conditional state of the database; and/or an undo module 1354 in communication with the journal-blocking module 1352 and configured to facilitate mutation reversal.

In one embodiment, a changeset-journaling module does not restrict journaled database mutations to any particular data type. Accordingly, such a CMS may be able to easily adapt to any particular database system.

More, the application-interface module may be integrated into an application as a connector decorator, the application-interface module and the database-interface module may be in modular communication with the application and the database, respectively, such that the database changeset management system is middleware between the application and the database, and/or the database-interface module may be integrated into a database as a stored procedures system. Further, it may be that the query-analysis module matches queries against a characteristic set and triggers an interest protocol on a match.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although particular technology and software systems are described, it is envisioned that other systems may be used, including those not yet in existence.

Additionally, although the figures illustrate particular connections between modules, such is exemplary and non-limiting. In particular, other non-illustrated connections/communication is contemplated and an illustrated connection/communication or lack thereof does not imply the negative of an alternative. Further, it is envisioned that each and/or any of the modules described herein may be in communication with each/any other module described herein.

Finally, it is expected that there could be numerous variations of the design of this invention. An example is that an embodiment of the invention may exist as or part of a management system, a security system, a productivity system, an entertainment system, etc., and the like.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A database changeset management system configured to generate a record of changesets for a database, comprising:
a) an application-interface module configured to receive queries from an application and provide returns to an application;
b) a query-analysis module in communication with the application-interface module and configured to analyze a query according to an analysis protocol;
c) a query-processing module in communication with the query-analysis module and configured to process queries according to a processing protocol thereby generating database mutation statements;
c) a changeset-journaling module in communication with the query-processing module and configured to journal database mutations based on database mutation statements;
d) a journal-blocker module in communication with the changeset-journaling module and configured to record blocking relationships among journaled database mutations; and
e) a database-interface module in communication with the query-processing module and configured to send queries to and receive returns from a database.

2. The database changeset management system of claim 1, wherein the changeset-journaling module does not restrict journaled database mutations to any particular data type.

3. The database changeset management system of claim 1, wherein the application-interface module is integrated into an application as a connector decorator.

4. The database changeset management system of claim 1, wherein the application-interface module and the database-interface module are in modular communication with the application and the database, respectively, such that the database changeset management system is middleware between the application and the database.

5. The database changeset management system of claim 1, wherein the database-interface module is integrated into a database as a stored procedures system.

6. The database changeset management system of claim 1, wherein the query-analysis module matches queries against a characteristic set and triggers an interest protocol on a match.

7. The database changeset management system of claim 1, further comprising a database-restriction module in communication with the query-processing module and configured to return selective queries based only on expected returns derived from the changeset-journaling module, thereby reducing required communication through the database-interface module.

8. The database changeset management system of claim 1, further comprising a return-check module in communication with the database-interface module and configured to compare an actual return from a database to an expected return derived from the changeset-journaling module.

9. The database changeset management system of claim 8, further comprising a return subtraction module in communication with return-check module and configured to return a difference between an actual return and an expected return.

10. The database changeset management system of claim 1, further comprising a collaboration module in communication with the application-interface module and configured to permit a plurality of applications to collaborate simultaneously with the changeset management system.

11. The database changeset management system of claim 1, further comprising an alternate-state-return module in communication with the changeset-journaling module and configured to return based on a conditional state of the database.

12. The database changeset management system of claim 1, further comprising an undo module in communication with the journal-blocking module and configured to facilitate mutation reversal.

13. A method of database changeset management for automated information enhancement and control over changesets using a computational device, the steps comprising:
a) receiving a query from an application;
b) analyzing the query according to an analysis protocol;
c) processing the query according to a processing protocol, thereby generating a processed query having database mutation statements;
d) journaling a database mutation statement into a changeset-journaling module;
e) recording a blocking journal entry based on a blocking characteristic of the processed query into a journal blocker module;
f) sending a database mutation statement to a database; and
g) checking an undo request against the blocking journal entry.

14. The method of claim 13, further comprising the step of comparing a query to an interest set and triggering an interest protocol on a match.

15. The method of claim, 13, further comprising the step of returning a response to the query based solely on information from the changeset-journaling module.

16. The method of claim 13, further comprising the steps of: deriving an expected return from information stored in the changeset-journaling module; comparing an actual return from the database to the expected return; and
generating a difference instruction between the actual return and the expected return, wherein the difference instruction includes a set of statements configured to transform between the actual and expected returns.

17. The method of claim 13, further comprising the steps of:
providing a list of journal ids for all journals within a specified timeframe and satisfying a predetermined characteristic; and
providing journal information in response to a query regarding a provided journal id.

18. The method of claim 13, further comprising the steps of:
providing a second changeset-journal module configured to journal an alternate database state; and
returning a query result based on the alternate database state.

19. The method of claim 18, further comprising the steps of:
comparing a query to an interest set and triggering an interest protocol on a match;
returning a response to the query based solely on information from the changeset-journaling module;
deriving an expected return from information stored in the changeset-journaling module;
comparing an actual return from the database to the expected return; and
generating a difference instruction between the actual return and the expected return, wherein the difference instruction includes a set of statements configured to transform between the actual and expected returns;
providing a list of journal ids for all journals within a specified timeframe and satisfying a predetermined characteristic; and
providing journal information in response to a query regarding a provided journal id.

20. A database changeset management system configured to generate a record of changesets for a database, comprising:
a) an application-interface module configured to receive queries from an application and provide returns to an application;
b) a query-analysis module in communication with the application-interface module and configured to analyze a query according to an analysis protocol, wherein the query-analysis module matches queries against a characteristic set and triggers an interest protocol on a match.;
c) a query-processing module in communication with the query-analysis module and configured to process queries according to a processing protocol thereby generating database mutation statements;
c) a changeset-journaling module in communication with the query-processing module and configured to journal database mutations based on database mutation statements, wherein the changeset-journaling module does not restrict journaled database mutations to any particular data type.;
d) a journal-blocker module in communication with the changeset-journaling module and configured to record blocking relationships among journaled database mutations;
e) a database-interface module in communication with the query-processing module and configured to send queries to and receive returns from a database;
f) a database-restriction module in communication with the query-processing module and configured to return selective queries based only on expected returns derived from the changeset-journaling module, thereby reducing required communication through the database-interface module;
g) a return-check module in communication with the database-interface module and configured to compare an actual return from a database to an expected return derived from the changeset-journaling module;
h) a return subtraction module in communication with return-check module and configured to return a difference between an actual return and an expected return;
i) a collaboration module in communication with the application-interface module and configured to permit a plurality of applications to collaborate simultaneously with the changeset management system;
j) an alternate-state-return module in communication with the changeset-journaling module and configured to return based on a conditional state of the database; and
k) an undo module in communication with the journal-blocking module and configured to facilitate mutation reversal.
